(19) United States
(12) Patent Application Publication
(10) Pub. No.: US 2017/0187749 A1
(43) Pub. Date: Jun. 29, 2017

(54) PRIVACY MANAGEMENT FOR COMPUTING DEVICES

(71) Applicant: Intel Corporation, Santa Clara, CA (US)

(72) Inventor: Stuart Tyler, Hillsboro, OR (US)

(73) Assignee: Intel Corporation, Santa Clara, CA (US)

(21) Appl. No.: 14/757,917

(22) Filed: Dec. 24, 2015

(51) Int. Cl. H04L 29/06

(52) U.S. Cl. CPC H04L 63/20; H04L 63/10

(57) ABSTRACT

The techniques herein provide for a system and method for privacy management between computing devices. The method includes defining, via a first computing device, a user privacy policy for the first computing device based on the privacy preferences of a user of the first computing device, the user privacy policy to be asserted in machine readable format across multiple computing devices requesting access to data of the first computing device. The method includes receiving at the first computing device an access request from a second computing device. The method also includes asserting, via the first computing device, the user privacy policy in the machine readable format to the second computing device.

### TECHNICAL FIELD

The present techniques relate to privacy management, and more particularly, to executing a privacy management framework with a computing device and remote devices.

### BACKGROUND ART

As computing devices become more sophisticated, more mobile, and more connected, users of computing devices are concerned with privacy settings and preferences when communicating with other devices and applications the users interact with every day. The computing device may be a smartphone, smart device (e.g., smart watch), tablet, personal computer or desktop computer, laptop, television, gaming console, etc. A person may use a computing device having hardware and software applications to access various data through wired networks, wireless networks, and wireless connections including radio, near field communication (NFC), Bluetooth®, and the like. In the competitive business of consumer electronics and services, there exists an ongoing need for continuous improvement in security, privacy, reliability, user-experience, affordability, and so forth.

### BRIEF DESCRIPTION OF DRAWINGS

FIG. 1 is a block diagram of a device configured for privacy management in accordance with embodiments of the present techniques.

FIG. 2 is a block diagram of a system employing a computing device in accordance with embodiments of the present techniques.

FIG. 3 is a block diagram of a system configured for privacy management in accordance with embodiments of the present techniques.

FIG. 4 is a block flow diagram of a method of privacy management for a computing device in accordance with embodiments of the present techniques.

FIG. 4A is a block flow diagram another method for privacy management between computing devices in accordance with embodiments of the present techniques.

FIG. 5 is a diagram of system including a computer device, the diagram illustrating privacy management and communication techniques between the computer device and remote devices.

FIG. 6 is a block diagram depicting an example of a tangible non-transitory, computer-readable medium that can facilitate customization of privacy management of a computing device in accordance with embodiments of the present techniques.

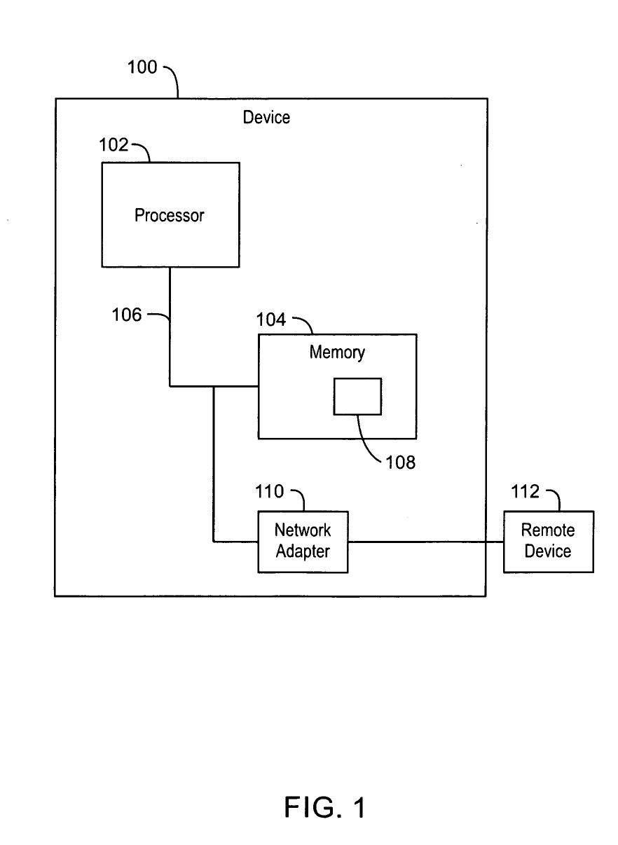

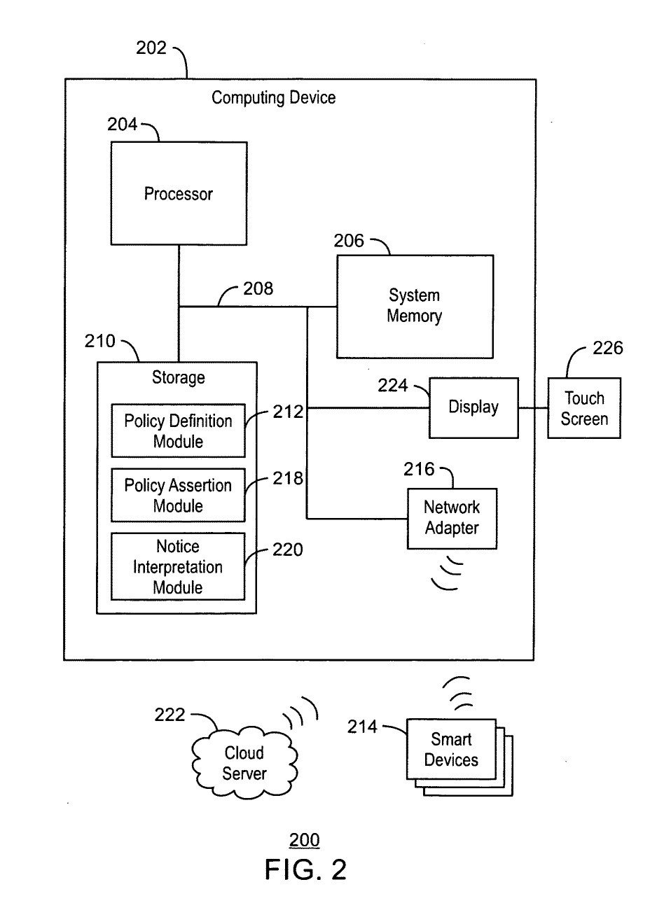

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

Embodiments of the present techniques may include a privacy management framework to provide a consistent way for users to assert their privacy preferences across devices/applications, including when users are traversing the public environment. The framework may provide for data collectors and subsequent processors to determine user privacy preferences when collecting or in receipt of personal information from the user. Examples may encompass a first computing device (e.g., a user computing device) and a second computing device (e.g., a receiving computing device such as remote computing device wirelessly coupled to the first computing device and that desires to receive data from the first computing device). In some systems, there may be “multiple” or a plurality of second computing devices.

The privacy management frameworks may consist of several components or elements. In some examples, the framework may include: (1) a user definition tool at the user computing device that facilitates the user to define user preferences, and the user definition tool to convert the user preferences into machine readable format; (2) a user assertion tool at the user computing device that asserts or transmits the user preferences (e.g., in machine readable format) to remote computing devices (receiving computing devices); (3) a remote interpretation engine at the remote receiving computing devices to interpret the user-defined privacy preferences provided by the user assertion tool of the user device; (4) a remote notice assertion tool at the receiving devices (e.g., remote IoT devices) that communicates information practices to the user computing device; and (5) a notice interpretation tool at the user computing device that interprets information practices communicated from the remote notice assertion tool of the remote devices. Variations and modifications of this exemplary framework may be employed and accommodated.

Moreover, the aforementioned tools (and other tools) may be instructions or code stored in memory and executable by a processor. In one example, the user computing device has all five tools (1)-(5) listed above, executes tools (1), (2), and (5), and provides tools (3) and (4) to the remote computing device for execution at the remote computing device. For example, the remote computing device may read (3) the remote interpretation engine and (4) the remote notice assertion tool from the user computing device. Lastly, a metadata generation engine (e.g., executable code disposed on the user computing device and/or remote receiving devices or subsequent devices) may associate user privacy preferences with data collected, such that subsequent processors of the data may more readily view, interpret, and/or honor user preferences. The metadata may be stored on a network device, for example.

Thus, the present techniques relate generally to executing privacy management on a computing device (e.g., a first computing device or user computer device), and more particularly, to automatic assertions by the computing device. The techniques may relate to second or remote computing devices automatically interpreting and honoring user privacy settings of the computing device when the computing device communicates with the remote devices. Thus, embodiments may address the relationship between a user computing device with a data-receiving or remote computing device. Again, the receiving or remote device may be a device that receives or desires to receive data from the user computing device. The user computing device may be coupled to the receiving computing device by a wired or wireless connection.

In a particular example, the user computing device is a mobile device wirelessly coupled to an Internet of Things (IoT) device (receiving device) in the public arena. For instance, a user may be walking in public with a smart phone (user computing device). An IoT device such as a public smart camera (receiving device) wirelessly couples to the user smartphone and requests user data from the user smartphone. In another particular example, the user computing device is a tablet having a social media application, and the user couples (e.g., via the social media application and a combination of wireless and wired connections) to a remote server (receiving device) associated with the social media application. The remote server requests user data from the user tablet via the social media application.

The user computing device may be characterized as a device that provides user data in response to requests for such data. The user computing device may be a laptop or desktop computer, a tablet, a mobile device such as a smartphone, a wearable computing device, and so on. The receiving computing device may be characterized as a device that requests and receives user data from the user computing device. The receiving computing device may be an IoT device or smart device (such as in the public environment), a remote server including remote servers implementing applications, a laptop or desktop computer, a tablet, a mobile device such as a smartphone, a wearable computing device, and so on. The receiving computing device may be further coupled to data collectors or repositories, data processors, upstream servers, and so on, that accept collected user data from the receiving device for additional storage and processing of the data.

Examples herein provide a privacy management framework in the relationship of the user computing device with the receiving device and any data processors or upstream servers coupled to the receiving device. The organization or entity relying on the receiving device and directing any coupled data processors or upstream servers may better satisfy their privacy guidelines with embodiments of the present techniques. As for the user with embodiments herein, the user and their user computing device may better and more efficiently define and communicate user preferences to the receiving device and the organization or entity associated with the receiving device.

As discussed, the present techniques relate generally to customizing and enforcing privacy management techniques for a computing device in communication with other devices and applications. Embodiments may facilitate the computing device to enforce user privacy settings, and facilitate communication across various remote devices and/or applications. Examples are directed to privacy customization and automatic privacy notice and interpretation for content through various mediums, networking, and communications. Such communications may be via wired or wireless protocols, Internet of Things, and similar systems and protocols. In particular examples, with the advent of smart devices and Internet of Things, beneficial use cases can be developed including with the user of a computing device on one end, and with application service-providers and others on the other end, making use of devices around the user to augment the user and service-provider experiences.

Organizations, including application service-providers, data collectors, and other entities, around the world may endeavor to determine how to introduce new privacy management solutions in compliance with their legal and regulatory obligations. International and domestic privacy laws and regulations, as well as non-legal or non-regulatory privacy implementations, may be based, at least in part, on a premise that users/individuals should be informed about data management practices of an organization or entity, and the individuals and their devices be offered the choice to decide whether to participate in a specific engagement or not. This “notice” and “choice” regime, and similar regimes, have become increasingly challenged with the introduction of new technology and particularly with the advent of the Internet of Things, for example. There is a general concern that the advent of IoT and “Big Data” make meeting personal privacy requirements more difficult. Embodiments of the privacy management techniques presented herein may address these requirements and issues, thereby facilitating organizations to address their legal privacy obligations, while accommodating innovative use of data.

In general, the IoT may be the network of physical objects or “things” embedded within electronics, software, sensors, and connectivity to facilitate objects to collect and exchange data. The Internet of Things may facilitate objects and devices to be sensed and controlled remotely across existing network infrastructure, creating opportunities for more direct integration between the physical world and computer-based systems. Each “thing” may be uniquely identifiable through its embedded computing system and able to interoperate within the existing Internet infrastructure. Moreover, such “things” interconnected and smart may promote collection of large amounts of data from public and personal spaces, the home, businesses, academic environments, government facilities, and so forth. Indeed, such data collection associated with IoT and IoT sensors, and other technologies, may contribute to Big Data. Big Data may be a term used to describe the exponential growth and availability of data, both structured and unstructured. Big Data may be a term for collection of data sets so large and complex that processing is difficult using traditional data processing applications.

The privacy management may include or accommodate connected devices, gaming, IoT, mobile devices, tablets, personal computers (PC), smart devices, laptops, and so on. A myriad of computer devices and applications in relative proximity to a user computing device may attempt to communicate with the user computing device, and send and receive information to and from the user computer device. Content creators, application developers, and servers and devices with wireless communication may compete to gain access to data and/or processing power from a user's computing device. It is generally beneficial for a user to quickly and relatively easily identify when an access request is sent to the user's computer device, and the user to decide whether to permit the specific requested access by the particular application or device sending the access request.

Examples herein may advance the user experience, security and reliability, for instance, by customizing privacy settings for the environment around the user while the user engages with content. Devices at home or business, in government facilities, public places, universities, etc., connected through Internet of Things, for example, may be affected. Certain embodiments create or provide an interface (e.g., a standardized interface) between a user computer device with IoT devices (smart devices), remote servers, etc. to dynamically customize the user privacy settings for content being communicated and/or consumed. Smart devices may include, for example, a smart light, a smart thermostat, smart camera, smart watch, computer glasses, smart appliances such as a smart refrigerator, and so on. The remote servers may include servers executing applications interfacing with associated applications on the user device, and other servers. The smart devices (including in the public environment) and the remote servers may be receiving devices in the sense of receiving or desiring to receive data from the user device.

The Internet of Things is a growth area, and the present techniques may offer a holistic, scalable technical solution that addresses privacy issues (e.g., legal and non-legal requirements) for the IoT and Big Data, including with respect to organizations, individuals, providers, users, and so forth. Indeed, certain embodiments facilitate a user and user device to determine whether or not to grant access requests, and on the other end, also facilitate service-providers and their receiving devices to implement notice and choice provisions to a user and user devices. In general, examples herein may address, resolve, and/or at least partially satisfy privacy concerns and issues, and legal, regulatory, and compliance factors with privacy, and the like. For instance, examples provide for several components (e.g., memory storing code executable by a processor) that facilitate individuals or users to assert their privacy preferences (choices) to organizations, and the organizations are then able to interpret these assertions and act or respond accordingly. The actions or responses by the organizations may be within public or private guidelines, and organizational procedures, and/or in compliance with relevant privacy legislation and regulatory requirements, and so on. Organizations (application owners, content providers, IoT manufacturers, etc.) may be able to provide privacy notice in a consistent and readily accessible manner, to meet their business guidelines or legal obligations. Lastly, while the discussion herein may allude to laws and regulations, it should be emphasized that embodiments of the present techniques are not limited to laws or regulations.

As indicated in the discussion above, certain privacy laws in the world may mandate that data collectors be transparent regarding their data handling practices, and provide user control and honor user preferences. As also indicated, there is a general concern that IoT and Big Data may make meeting these requirements more difficult. Embodiments of the privacy manager framework may address these issues while not inhibiting beneficial use of data generally. Particular embodiments provide for users to predetermine and assert their privacy preferences across their devices/applications, such that data collectors and subsequent processors when collecting or in receipt of personal information from the user devices/applications may be able to determine the user's privacy preferences. The implementations may be helpful when the user is traversing the public environment, as well as in non-public settings.

The aforementioned framework is now discussed in more detail. In some examples, as indicated, a component of the framework may be a user privacy preference/policy definition tool or “user definition tool” which may facilitate the user to define their privacy preferences. The definition tool may provide a user interface (UI) to facilitate the user in defining their user personal privacy preferences. Therefore, the user may not have to familiarize with or directly employ the UI or controls of each individual receiving device or application. In addition, the UI may have various granular/advanced features. Moreover, the definition tool may convert the user-defined settings into machine readable settings that can be asserted or transmitted to data-receiving/collecting devices including smart or IoT devices, personal and public devices, devices having applications (e.g., mobile applications, social media, etc.), and servers and service-provider devices implementing applications, data collection, and so forth. Therefore, in certain examples, user privacy or policy preferences may be formulated by the user in a consistent manner for a variety of remote devices and applications. Again, the definition tool may convert the user-defined settings into a machine readable format or computer readable format and that can be asserted to (transmitted to and read by) data-receiving entities such as personal devices and applications (e.g., social media and other applications) on mobile devices, home devices, and/or on remotes servers, and so forth. For receiving devices and receiving applications/servers that cannot meet the preferences, the definition tool may alert the user and provide the user with options. For example, these options may be for the user to change their settings for that particular context, or to decide not to proceed, and the like.

Another tool may be a user privacy preference assertion tool or “user assertion tool” which may communicate the user preferences (e.g., defined via the aforementioned definition tool) to data-receiving devices including remote devices, IoT devices in the public environment, application servers, and so on. The user computing device having the assertion tool may communicate, via the assertion tool, the user preferences in the machine readable format to receiving or remote/IoT devices in the private and public environments by radio, for example. In accordance with embodiments, the receiving or remote/IoT devices with receipt of the asserted user preferences (e.g., asserted via the user assertion tool) may then be able to interpret the assertions and act accordingly. The responsive actions by the receiving devices including IoT devices, remote servers, or applications, and so on, may be to not collect data about that user or to not append certain user data to metadata, etc. Such interpretation and responsive action by the remote or receiving devices may facilitate the receiving or collection entities and organizations to meet the user's privacy preferences in view of the user data and metadata passed along to remote servers and subsequent processors, and the like.

Yet another element or component for privacy management may be a user privacy preference interpretation engine for the remote devices. In one example, a component labeled as a “remote interpretation engine” can be read from the user computing device by receiving devices. Again, remote receiving devices can include personal devices, mobile devices, remote devices (e.g., IoT devices, remotes servers, etc.), service-provider devices, organization devices, and applications disposed on those devices. The remote receiving computing devices may be in the public environment and/or in private settings. The remote interpretation engine may be read by the receiving or remote devices from the user computing device, and/or stored and utilized by the receiving or remote devices to facilitate those devices to interpret the user-defined privacy preferences provided (e.g., via the aforementioned user assertion tool) by the user computing device in machine readable format to the receiving or remote device. Thus, the user preferences can be read and acted on by the receiving devices.

In certain examples, another component of a privacy management framework may be a remote/IoT device privacy-notice assertion tool or “remote notice assertion tool” that communicates information collection practices to user devices. The remote notice assertion tool may facilitate receiving or remote/IoT devices to communicate (e.g., over radio) their information handling practices to user computing devices, such that user may decide what information to share and other behavioral decisions.

Another element or component of the framework may be, for example, a user notice interpretation tool or “notice interpretation tool” that interprets remote/IoT privacy notices from the aforementioned remote notice assertion tool of the remote devices, and displays the interpretation to the user. Thus, the user notice interpretation tool may interpret remote notices received from remote (receiving) devices. The notice assertion tool may be able to interpret machine readable remote/IoT privacy notices from remote devices, and display locally the notices from the remote devices in a human readable format to the user to facilitate the user to make choices dependent on the context.

FIG. 1 is a block diagram of a device 100 configured for privacy management in accordance with embodiments of the present techniques. The device 100 can be a computing device for a user, such as a personal computer (PC) or desktop computer, laptop, server, gaming console (with or without an associated television or display monitor), television, mobile device (e.g., tablet, smartphone, etc.), smart display monitor, smart device, and so forth. The device 100 may provide user data and information to requesting remote devices 112, which may be characterized as receiving devices in this context. In a specific example, the device 100 is a mobile computing device such as a smartphone or wearable computing device, and in which a user may carry the device 100 in public environments having remote devices 112 such as IoT devices.

In the illustrated embodiment, the device 100 has a processor 102 such as a hardware processor, a microprocessor, a central processing unit (CPU), and the like. The processor 102 may be multiple processors and/or each processor 102 may have multiple cores. The device 100 has memory 104, such as non-volatile memory (hard drive, read-only-memory or ROM, flash memory, cards, etc.), volatile memory (e.g., random access memory or RAM, etc.), and other types of memory. The processor 102 and memory 104 and other components in the device can be connected via a bus 106. The memory 104 can include stored executable applications and instructions 108. Moreover, while FIG. 1 represents a single device 100, the processor(s) 102 and memory 104 having the stored executable applications and instructions 108 may instead or additionally be in a distributed computing system such as across multiple compute nodes.

In the illustrated example, the memory 104 stores privacy application(s) or module(s) as instructions 108 (e.g., code, logic, etc.), and additional instructions 108, executable by the one or more processors 102. As discussed in more detail with respect to subsequent figures, the modules may be, for example, a user interface privacy application or module, and privacy preference interpretation application or module, to name a few privacy management applications or modules. The instructions 108 may be executed by the processor 102 to implement privacy management (including in the home, business, in public, for government organizations, etc.) and to implement the techniques generally as discussed herein, such as with user computing devices and with remote device configurations with IoT and Big Data considerations. The device 100 may be configured with a network adapter 110 to couple with and interact with a remote device 112, such as smart devices, computing devices, servers, a remote network, a cloud network (“the cloud”), and other devices and machines, and the like, capable of communication (e.g., wireless communication) with the device 100. In examples, the network adapter 110 may be a wireless network adapter to wirelessly couple the device 100 with smart devices so that the device 100 and smart devices may interact to implement privacy management techniques. In some examples, the network adapter 110 may provide for wired (e.g., Ethernet, etc.) network connections with the smart devices, a wired network grid coupling smart devices, other computing devices, and so forth.

Again, privacy management applications may be stored in the memory 104, and/or provided externally. The device 100 may be wirelessly connected to a remote device 112 such as smart devices or servers. The device 100 may be configured to enhance the user experience by asserting user privacy settings. Again, to so implement, the device 100 may store executable instructions 108 in the memory 104, such as an application framework, a transport module, and the like. The application framework when executed via the processor 102 may provide for substantially secure communication with a connected remote device 112 that is requesting access to the device 100.

In some examples, the application framework may be an API layer that handles the operating system (OS) specific details. The application framework may present a programming interface to a particular privacy management application. In examples, platform specific transport may include Bluetooth®, Wi-Fi, Wi-Fi Direct®, near field communication (NFC), radio, Ethernet, and so forth, to communicate with the remote device 112. The transport module may be an abstraction that includes transport techniques offered by the platform, and which include hardware for the aforementioned protocols (Bluetooth®, Wi-Fi, Wi-Fi Direct®, NFC, Ethernet, wired protocols, and other protocols), and their associated drivers and API modules. In examples, communication with a remote device 112, such as an external smart device or remote server, may depend on whether the smart device or server is interpreting the privacy setting asserted by the device 100, and the smart device or server honoring those settings.

The remote device 112 may have at least one transport medium in common with the device 100 or other computing devices. In some examples, the privacy management techniques can provide a security mechanism to typically allow only authorized devices to access the smart devices. For instance, someone within range may not use their mobile device to control a remote device 112 present inside the house of the user of the device 100 without authorization in certain examples. In order to protect user's privacy, an OS level check may be enforced when a device 100 or media application attempts to access each remote device 112.

It is to be understood the block diagram of FIG. 1 is not intended to indicate that the device 100 is to include all of the components shown in FIG. 1 in every case. Further, any number of additional components can be included within the device 100, depending on the details of the specific implementation of privacy management described herein.

FIG. 2 is a block diagram of a system 200 employing a computing device 202 in accordance with embodiments of the present techniques. In examples, the computing device 202 can be the device 100 (of FIG. 1). The computing device 202 includes a processor(s) 204 and system memory 206 coupled by a bus 208. The system memory 206 may include, for example, volatile memory such as RAM, cache, etc. The bus 208 can also connect to other components of the computer device 202, including memory or storage device 210. The storage device 210 is memory (e.g., non-volatile memory) that includes or stores code (instructions, logic) executable by the processor 202 to direct the processor 202 to perform techniques described herein such as those related to privacy management for requests from various remote devices and applications. As discussed below, portions of the code may be labeled as different software modules executable by the processor 202. The storage device 210 can be, for example, a basic input/output software (BIOS) as well as other firmware of the system, a hard disk drive (HDD), a solid state drive (SSD), and other non-volatile storage or memory.

The storage device 210 may store a number of executable software modules to implement the functions described herein. The modules stored in storage memory device 210 may be executed by the processor 204 (including utilizing system memory 106 in certain examples). Moreover, these modules may be part of a privacy management framework. For example, a policy definition module 212 may provide for the user of the computing device 202 to define their privacy preferences. In this example, the policy definition module 212 can convert the user-defined privacy settings into machine readable settings that can be asserted to smart devices 214 such as personal computing devices and IoT devices. The settings can be, for example, with respect to mobile applications, social media, etc. The computing device 202 can include a network adapter 216 to facilitate communication with various smart devices 214 that request access to the computing device 202. The devices 202 and 214 can be communicatively coupled via wireless communication protocols such as radio (e.g., Wi-Fi) Bluetooth®, and NFC, to name a few.

The storage device 210 may include a policy assertion module 218 that communicates user privacy preferences to smart devices 214 like devices remote from the computing device 202. For example, a smart device 214, such as an IoT device, in the public environment can receive the machine-readable privacy settings that have been defined by the user and converted by the policy definition module 212. The storage device 210 may also include a notice interpretation module 220. The notice interpretation module 220 can interpret privacy notices from smart devices 214, and display the privacy notices to the user of the computing device 202.

The computing device 202 may be a television (TV), a computer system (optionally having a display monitor), a laptop, an all-in-one computer, a gaming console (with or without an associated television or display monitor), a tablet, a smartphone, a wearable computing device such as a smart watch or computer eye glasses, and so on. The computing device 202 can be coupled through the network adapter 216 to a server 222, for example, a cloud server. In some examples, the server 222 can generate and/or store metadata related, at least in part, to a user and their privacy settings that have been asserted by the computing device 202, which is honored by subsequent smart devices 214. In some embodiments, these actions related to metadata generation and/or storage may be performed at the computing device 202. In the illustrated embodiment of FIG. 2, the arrangement or system 200 may accommodate user privacy notice and choice regimes, and other privacy management implementations. The computing device 202 can respond automatically, semi-automatically, or manually to a privacy notice and an access request.

Various input/output (I/O) devices may be present within the system 200. Specifically shown in the embodiment of FIG. 2 is a display 224, which may be a high definition LCD or LED panel. This display panel may also provide for a touch screen 226, e.g., adapted externally over the display 218 such that via a user's interaction with the touch screen 226, user inputs can be provided to the computing device 202 to enable desired operations, e.g., for making phone calls, accessing a particular application, selecting a desired point of interest, selecting a desired privacy setting for a particular application or remote smart device 214, and so forth. In one embodiment, the display 224 may be coupled to processor 204 via a display interconnect that can be implemented as a high performance graphics interconnect. The touch screen 226 may be coupled to processor 202 via another interconnect, which in an embodiment can be an I2C interconnect. Lastly, while block 214 of FIG. 2 depicts “smart devices” 214, the block 214 could also additionally represent remote server computing devices, for example.

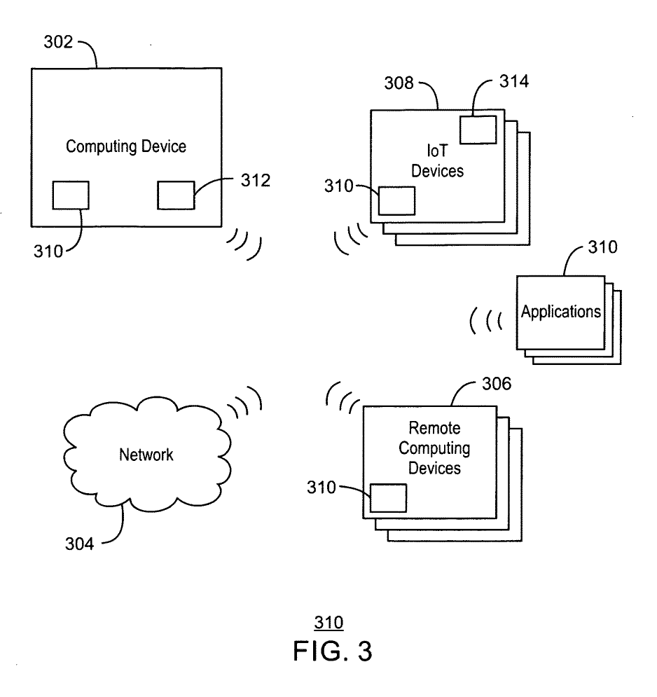

FIG. 3 is a block diagram of a system 300 configured for privacy management in accordance with embodiments of the present techniques. The system 300 includes a computing device 302 that can be described, for example, as with respect to computing device 202 of FIG. 2. The system 300 includes a network 304 that can communicate across various devices and provide for access to various data on the network 304. The network 304 can be part of a cloud network (“the cloud”), for example, and in some cases may help facilitate communication with various devices and software applications.

The system 300 also includes remote computing devices 306 and IoT devices 308. The computing device 302, remote computing devices 306, and IoT devices 308 may include and store applications 310 including software applications that when executed may request and collect data from the computing device 302. In the illustrated embodiment, the applications 310 depicted separate from the devices have associated hardware infrastructure (not shown) such as computer server implementation, delivery hardware, etc. The applications 310 may include software applications and mobile applications in the environment near the computing device 302 that are communicated wirelessly, and/or via wired communications from devices at geographic location different than the computing device 302. The remote computing devices 306 and IoT devices 308 can include many example devices, as “smart” computing devices become increasingly ubiquitous and found in every-day life. The applications 310 can include many example software applications that interact with and/or are delivered wirelessly to the computing device 302.

In this example, the computing device 302 has privacy management applications 312 in memory. A user (e.g., of the computing device 302) may interact with the applications 312. In examples, the privacy management applications 312 could be stored on the computing device 302 or otherwise locally, or include content from the network 304 or the cloud, and the like. The privacy management applications 312 interact with IoT devices 308, for example, through an IoT Application Program Interface (API) module 314. In examples, the privacy management applications 312 interact with the IoT API module 314, which is executable instructions stored in memory of the IoT device(s) 308, and which may have a language format known to the computing device 302 and the smart IoT devices 308 in the environment of the computing device 302. For instance, the IoT API module 314 could use a language such as Google Weave® or similar programs or languages, which may facilitate communication between devices, locally and in the cloud. In certain embodiments, data can be routed between various transport stacks available on the computing device 302, such as near field communication (NFC), Bluetooth®, Wi-Fi access point (AP) connection, and/or Wi-Fi Direct®, and the like. The term Wi-Fi may carry a trademark Wi-Fi®. Moreover, Wi-Fi Direct®, initially called Wi-Fi peer-to-peer (P2P), is a Wi-Fi standard facilitating devices to connect with each other without requiring a wireless access point, and may be usable for internet browsing, file transfer, and the like to communicate with more than one device simultaneously at typical Wi-Fi speeds, and so forth. Furthermore, the transport stack(s) may also be directed to Ethernet and/or other wired protocols.

The remote devices 306 may have a processor and memory storing instructions (code, logic) executable by the processor. In this example, the IoT devices 304 and the remote devices 306 in the environment surrounding the computing device 302 may be a light, a thermostat, a camera, and other smart devices. The IoT devices 304 and remote devices 306 may have stacks consisting of device hardware, with an API module as instructions stored in memory and executable by the respective processor of the remote device. The API module may run generally on top to control the hardware according to the commands the remote device API receives. In certain embodiments, a transport module includes executable instructions, e.g., operating above the API module, covers or “hides” the mechanism used to bring in the commands. The remote devices 306 may also include remote computer servers, for example.

Privacy guidelines or laws may mandate that data collectors are transparent regarding their data handling practices and that the data collectors provide a user of computing device 302 notice and control, and honor the user computing device 302 preferences. The components of system 300 mentioned herein may be in communication with one another in some examples, and may not be in communication in other examples. In examples, the components may send requests to computing device 302 in order to gain access to data that may or may not be sensitive to a user of the computer device 302. The privacy notice and user control techniques and other controls on data use discussed herein can be leveraged throughout the system 300 to honor established privacy rules and regulations. Thus, the system 300 can be to efficiently implement privacy management in a way that is user-friendly, secure, and effective for interactions across multiple devices and applications in the system 300.

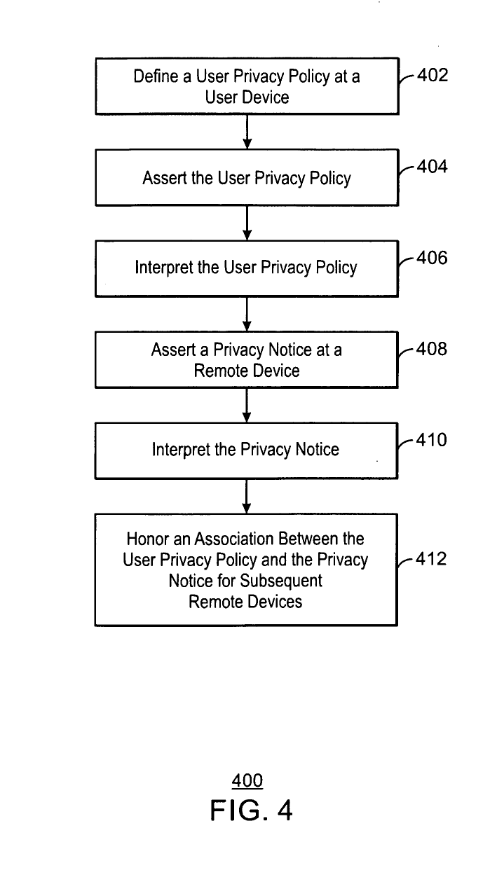

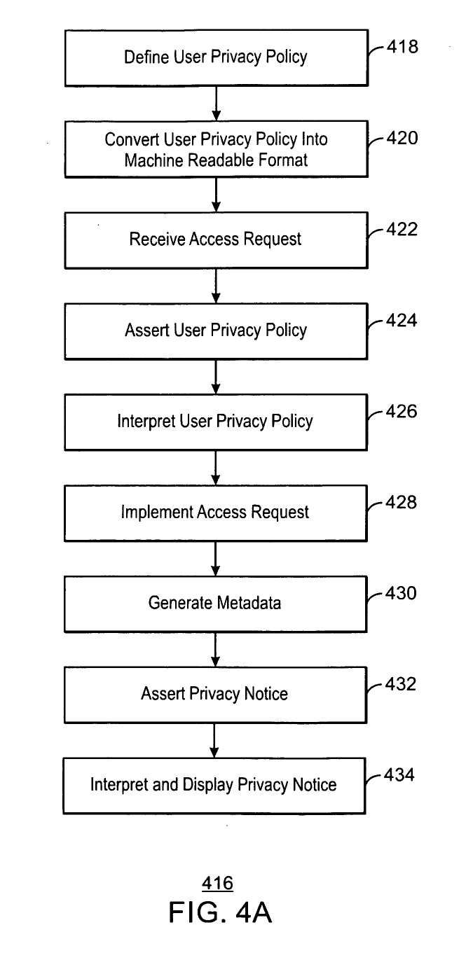

It is to be understood the block diagram of FIG. 3 is not intended to indicate that the system 300 is to include all of the components shown in FIG. 3 in every case. Further, any number of additional components can be included within the device 300, depending on the details of the specific implementation of privacy management described herein. In some examples, the system 300 of FIG. 3 can be used to implement the method described with respect to FIG. 4.

FIG. 4 is a block flow diagram of a method 400 of privacy management for a computing device in accordance with embodiments of the present techniques. The method 400 begins at block 402 where a user privacy policy is defined at a user device. A simple or more complex user interface (UI) can be introduced to a computing device for defining the user privacy policy, and the UI can have more granular or advanced settings, depending on the use case and other factors. In addition, the definition of the user privacy policy by the user and the computing device further includes converting the user-defined settings into machine readable settings, and thus facilitates the user to effectively define and assert their own personal privacy preferences to other devices. The machine readable settings can be read by receiving devices such as personal devices, smart devices, IoT devices, mobile applications, social media applications on devices, etc. in a consistent manner. This UI reduces or avoids the need for users to familiarize themselves with the UI and controls of every individual device or application they use. Devices and applications that cannot meet these preferences could alert the user to that and give the users various options, for example, to change their settings for that particular context or decide not to proceed, thereby allowing users to make choices and organizations to meet their organization guideline and/or legal obligations.

The method 400 continues at block 404, where the machine readable privacy settings are asserted by the user computing device to other devices and applications in the surrounding environment. The user privacy preferences (choices) are communicated to remote/IoT devices in the public environment wirelessly via radio, for example. Remote/IoT devices are able to interpret the assertions and act accordingly. Such action may include not collecting data about that user, for example. Other action may include, for example, appending the data collected with metadata, thereby ensuring user privacy preferences are passed along to subsequent processors that request access the data.

The method 400 continues at block 406, where the user privacy policy is interpreted. The user privacy policy is interpreted by the receiving devices including remote/IoT devices and applications. Upon interpretation of the user defined privacy preferences in machine readable format, the instructions can be read and acted upon by the receiving devices including personal devices, mobile applications and remote/IoT devices in the public environment, facilitating organizations to meet privacy guidelines and contractual or legal obligations, for example.

At block 408, a privacy notice is asserted by a remote device. The privacy notice from the remote/IoT device or application communicates the information collection practices and handling thereof (privacy notice) over, for example, radio to a user computing device. Such privacy notice assertion allows organizations to meet their guidelines or obligations to provide notice, while facilitating the user to make choices about the information they are willing to share, as well as other behavioral decisions, and the like.

At block 410, the privacy notice is interpreted. The machine readable notice asserted by the remote/IoT device is interpreted at the user computing device. The notice is then displayed in a human readable format so that the user can make appropriate choices in certain examples, depending on the context.

The method 400 concludes at block 412, where an association between the user privacy policy and the privacy notice is honored for subsequent remote devices. A metadata generation engine can be utilized for making and honoring the associations. For example, user privacy preferences can be associated with data collected by the remote/IoT device so subsequent processors of the data are able to read, interpret and honor user privacy preferences, and thus meet legal obligations. In examples, the metadata generation engine can be an application on the user computing device, on the remote/IoT device, and/or on an application provided by a cloud network.

In embodiments, the method 400 may include additional actions not shown in FIG. 4. Further, the method 400 might be performed with fewer actions than those described with respect to FIG. 4. For example, the generation of metadata and making further associations with user privacy settings across subsequent processors may or may not be included in the method 400, while additional actions of broadcasting machine readable privacy settings from device to device can also be included, and so forth. In some examples with remote devices or applications that cannot meet user privacy preferences, the user device could alert the user to that fact and give the user options. The options may include, for example, to change settings for that particular context, or decide not to proceed with permitting access.

FIG. 4A is a block flow diagram another method 416 for privacy management between computing devices in accordance with embodiments of the present techniques. At block 418, the method 416 includes defining, via a first computing device, a user privacy policy for the first computing device based on the privacy preferences of a user of the first computing device. The first computing device may employ a definition tool (executable code) to facilitate the user and the first computing device to define the user privacy policy. The first computing device may be a smartphone, a tablet, a laptop, a desktop computer, a wearable computing device (e.g., smart watch, computer eyewear, etc.), a server computing device, and other computing devices. The user privacy policy is defined to assert the user privacy policy in machine readable format across multiple computing devices such as computing devices requesting access to data of the first computing device. The user privacy policy, as defined, may provide a substantially consistent manner to direct user privacy settings to remote computing devices. Moreover, with the user privacy policy defined at the first computing device, the user may be relieved of utilizing an interface the second computing device (or other remote computing device) to specify privacy settings.

The user privacy policy may include privacy settings, such as a setting with respect to accessing contacts of the user on the first computing device, a setting with respect to allowing access to location data of the first computing device, and so forth. The defining of the user privacy policy may include the first computing device generating and displaying a user interface (UI) to the user to receive inputs from the user to define the user privacy policy (e.g., to be asserted across the multiple computing devices). The first computing device may store code executed by a processor of the first computing device to generate and display the UI, and wherein defining and asserting does not involve the user employing a user interface provided by the multiple computing devices including the second computing device. Lastly, the first computing device may be configured (e.g., with code executed by a processor) for the user to make a selection to enable the first computing device to broadcast assertions of the user privacy policy to the multiple computing devices.

At block 420, the method includes converting, via the first computing device, the user privacy policy into a machine readable format. A machine readable format is a format that can be understood by a mechanical device and not necessarily by a human. In examples, a machine readable format may be a format that is understood and processed by a computer. For instance, the machine readable format may be a format in a standard computer language that can be read automatically by a computing system.

At block 422, the method includes receiving at the first computing device an access request from a second computing device. The access request may be a request for data, such as access to the user contacts on the first computing device, or to the global position system (GPS) location of the first computing device, and so on. The second computing device may be a remote computing device wirelessly coupled to the first computing device. In one example, the second computing device may be a smart device (e.g., IoT device) in a public environment and within wireless range of the first computing device. Moreover, the second computing device may be a plurality of second computing devices or multiple computing devices.

At block 424, the method includes asserting, via the first computing device, the user privacy policy (e.g., in the machine readable format) to the second computing device. In certain examples, the assertion may be made in response to the access request. Moreover, in examples, the first computing device can assert the user privacy policy to a local application making a local access request, the local application stored and executing locally on the first computing device. Furthermore, the first computing device may alert the user and provide options to the user in response to the second computing device (or local application) unable to meet the user privacy policy. The options may include, for example, an option for the user to change a setting of the user privacy policy, an option for the user to choose not to proceed with the access request, an option for the user to allow an exception to the user privacy policy, and the like.

At block 426, the method includes interpreting the user privacy policy at the second computing device (or local application). In some examples, the interpreting of the user privacy policy includes the second computing device executing an interpretation engine provided by the first computing device. In other words, the interpretation engine (e.g., executable code) may be read by the second computing device from the first computing device. At block 428, the method includes implementing the access request (e.g., at the first computing device) in accordance with the user privacy policy as interpreted at the second computing device. In other words, the access request implementation honors the user privacy policy including the settings in the user privacy policy, and the first computing device grants access to the data requested by the second computing device in the access request in accordance with the user privacy policy.

At block 430, the method includes generating metadata, the metadata associating the user privacy policy with data collected via the access request by the second computing device from the first computing device. The metadata may be made available to a third computing device and other computing devices. The third computing device and other computing devices may utilize the metadata to satisfy the user privacy policy. The third computing device may be interacting directly with the first computing device and independent of the second computing device, and/or the third computing device can be, for example an upstream data processor or storage device coupled to the second computing device, and so on.

At block 432, the method includes asserting a privacy notice from the second computing device to the first computing device. For example, the second computing device may transmit the privacy notice to the first computing device in a machine readable format. The privacy notice may include practices of information collection and handling associated with the second computing device or related entity. For instance, the privacy notice may include notice with respect to marketing of user data.

At block 434, the method includes interpreting the privacy notice at the first computing device received from the second computing device. Further, the privacy policy may be displayed, via the first computing device, to the user in a human readable format. The privacy notice may inform the user so that the user can better make choices regarding the user privacy policy in relationship with the second computing device, such as what use data to share with the second computing device, or whether to end the communication or relationship with the second computing device, and so forth. Lastly, the method may include adjusting, via the first computing device, the user privacy policy in response to the privacy notice.

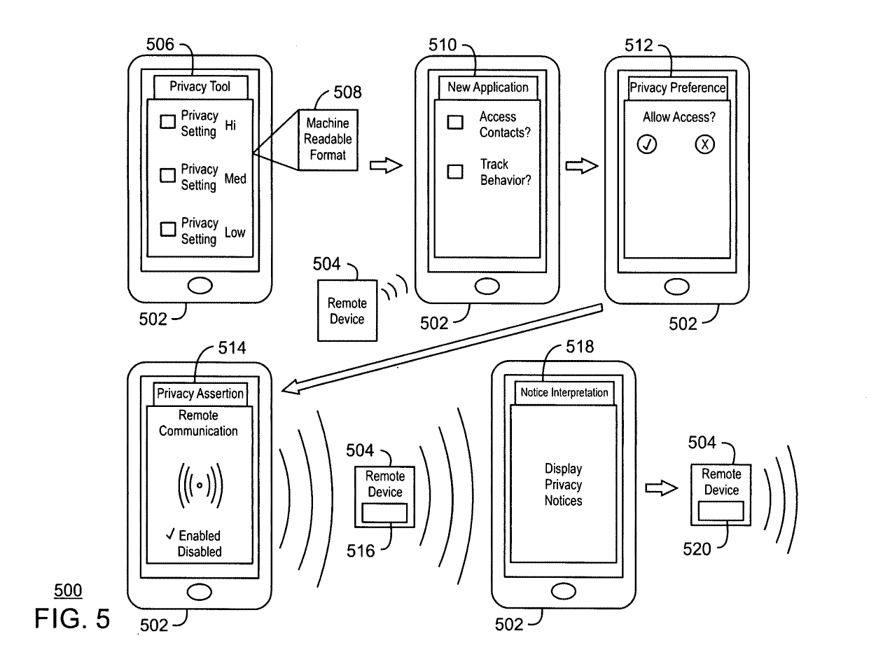

FIG. 5 is a diagram of a system 500 including a computer device 502, the diagram illustrating privacy management and communication techniques between the computer device 502 and a remote device 504. The computing device 502 may be analogous to the computing device 202 (FIG. 2) and the device 100 (FIG. 1) having the processor 102 and memory 104 with application(s) and instructions 106 executable by the processor 102. FIG. 5 depicts different stages of communication between the computing device 502 and the remote device 504, including display prompts issued to the user of the computer device and the actions that may be taken. The system 500 is to make the privacy management experience more efficient, for example, to allow the user to apply and assert their privacy settings across computer devices and applications. The user interface (UI) illustrated in FIG. 5 shows various displays a user of computing device 502 might encounter, and provides example selections a user may make.

The computing device 502 can include a privacy tool 506 (e.g., as instructions 106 or a module executable by a processor 102, 204 of analogous devices 100, 202). The privacy tool 506 provides for the user to choose a privacy setting. The privacy setting can be set by the user using the privacy tool 506 to, for example, high, medium, or low, or other settings, depending on context and the preferences of the user. The privacy tool 506 and computing device 502 can convert the selected user preference into machine readable format 508. The machine readable format 508 can be communicated to remote devices 504 in the environment near the computing device 502.

In examples, a new application 510 can be installed by the user (e.g., onto the computing device 502). The new application 510 (or a remote server associated with the new application 510) can ask permission to access data on the user's computing device 502. For example, the new application 510 may ask to access the contacts listed in the computing device 502, or track the behavior of the user of the computing device 502. The user may or may not wish to permit such accesses to occur, depending on the nature of the new application 510 and the type of data for which access is requested. It should be noted that the new application 510 may instead be an existing application prompted to request data not yet covered under an asserted privacy setting.

A privacy preference tool 512 (e.g., as instructions 106 or a module executable by a processor 102, 204 of analogous devices 100, 202) can also be part of the privacy management techniques used by the computing device 502 in the system 500. The privacy preference tool 512 can compare, for example, access requests originating from the new application 510 (or existing application) or remote device 504, to name a few, with a user privacy setting. The privacy preference tool 512 can determine whether to grant or deny such access requests. The privacy preference tool 512 can prompt the user of computing device 502 to change the current privacy settings, or to allow an access request based on an exception or setting related to a particular new application 510 or remote device 504.

A privacy assertion tool 514 (e.g., as instructions 106 or a module executable by a processor 102, 204 of analogous devices 100, 202) can also be used by the computing device 502. The privacy assertion tool 514 can be configured by the user of a computing device 502 to assert their preferred privacy settings to remote devices 504, for example. The privacy assertion tool 514 is to communicate the privacy settings wirelessly and in a machine readable format. A remote device 504 can receive the machine readable assertion of the preferred privacy settings and interpret the privacy settings defined by the user of computing device 502. The remote device 504 will then, when appropriate, act in accordance with the user-defined privacy settings established with the privacy tool 506.

A remote device 504 and/or application can also include a privacy notice assertion tool 516. The privacy notice assertion tool 516 permits a remote device 504, such as an IoT device or smart device, to define a device privacy notice. The device privacy notice can be broadcasted by the remote device 504 in machine readable format for interpretation by a user notice interpretation tool 518. The user notice interpretation tool 518 can be used for privacy management by interpreting the remote device 504 broadcast. The interpretation can be of the device privacy notice from machine readable format into a format that is displayed on computing device 502 and interpretable by a user, thus fulfilling the owner of a remote device 504 legal obligations when requesting access.

In some examples, a remote device 504 can include a metadata generation engine 520. In other examples, a metadata generation engine can be included in nodes connected via a network or on the cloud (not illustrated), for instance. The metadata generation engine 520 can be to associate user data preferences that have been asserted by the privacy preference tool 512 in machine readable format to data collected by a remote device 504 or application. The metadata generation engine 520 allows an automatic recognition of and efficient interpretation of privacy preferences with associated kinds of data, such that subsequent processors of data are able to see, interpret and honor those user privacy preferences, for example.

The system 500 illustrates a consistent technique for individuals to assert their privacy preferences across devices and applications, or when traversing the public environment. The system 500 is effective for data collectors and processors to determine the user privacy preferences when collecting or in receipt of personal information. The system 500 also provides a consistent technique for organizations to assert their privacy practices in machine readable format, and to adhere to notice and choice and other privacy obligations.

Embodiments of the present techniques may account for the duration of assertion of policies, and for persistence or time management aspects with respect to the assertions. In general, the user preferences or privacy preferences defined by the user via the user definition tool may be a function of time or of a time period. Similarly, the policy or policies asserted (to the user device) by the receiving device (e.g., the IoT device) via the notice assertion tool at the receiving device may be a function of time or of a time period.

In examples of user definition of privacy settings, the user definition tool may provide for identifying a window of time, for instance, for particular settings (e.g., a window of two weeks while the user is on vacation or in a particular location). Indeed, the user definition tool may accommodate a time-based persistence component for the user privacy settings. In other examples, the user via the user definition tool may specify granular exceptions based on time to the standard privacy settings chosen, and the like. Other aspects and functions of time with respect to the user privacy setting and the user definition tool may be applicable. Moreover, the user-defined privacy settings defined via the user definition tool may be specified as a function of location (e.g., location as noted by a Global Positioning System or GPS of the user computing device), and so on. Additional bases for the settings may be addressed.

As for the receiving computing devices (e.g., IoT devices) and the associated organization or entity, a time-based persistence component(s) with respect to notices and policies may also be implemented. As discussed, a remote notice assertion tool at the receiving devices (e.g., remote IoT devices) may communicate information practices and other notice to the user computing device. Such a notice or policy (e.g., of information practices or access) may be revised over time. The receiving computing device may present and assert the updated policy to the user computing device (e.g., when the user computing device is in vicinity of the receiving device or IoT device). Furthermore, outside of general updates, the policy may be a function of time, such as the time of day, the time of year, an occurrence of an exceptional event, a particular time window, and so on. In one particular example, the public IoT devices (e.g., smart cameras) assert a different policy contemporaneous with the presence of a significant dignitary in the public location. In another particular example, a parking barrier as an IoT device provides notice allowing vehicle access during the day but not at night, depending on the user privacy settings asserted by the user computing device, for instance. The notice and policy asserted by the receiving device may be a function of time, an occurrence, location, and other bases.

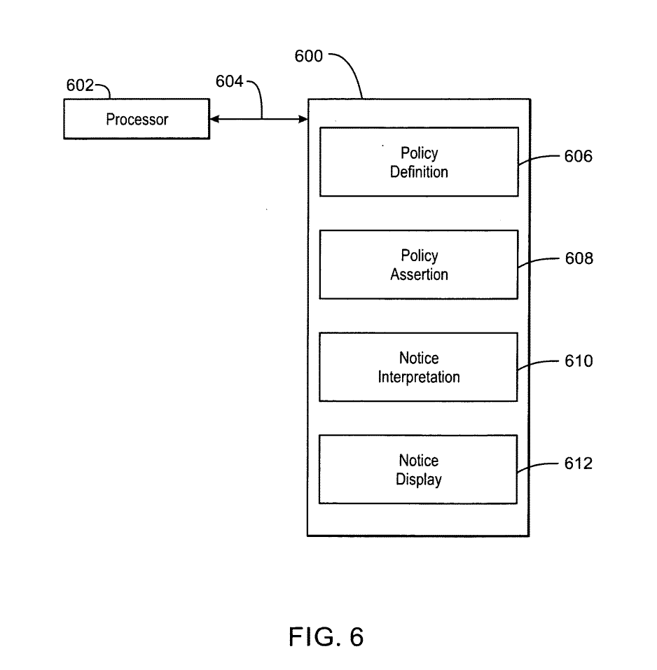

FIG. 6 is a block diagram depicting an example of a tangible non-transitory, computer-readable medium 600 that can facilitate customization of privacy management of a computing device in accordance with embodiments of the present techniques. The computer-readable medium 600 may be accessed by a processor 602 over a computer interconnect 604. The processor 602 may be a processor (e.g., 102) of the computing device. The tangible, non-transitory, computer-readable medium 600 may include executable instructions or code to direct the processor 602 to perform the operations of the techniques described herein.

Various software components discussed herein may be stored on the tangible, non-transitory, computer-readable medium 600, as indicated in FIG. 6. For example, with respect to privacy management directed toward a computing device, a privacy policy definition module 606 (executable code/instructions) may direct the processor 602 to provide a user interface for allowing a user to define preferred privacy settings for certain types of data. The policy definition module 606 can also direct the processor 602 to convert such user defined privacy settings into machine readable format. Similarly, a privacy policy assertion module 608 may provide for the communication of the machine readable privacy settings wirelessly to remote devices and applications. The policy assertion module 608 can enable remote devices to more effectively interpret the policy assertions made by the user with regard to specific data.

The executable instruction or code of the computer-readable medium 600 that direct the processor 602 may include a notice interpretation module 610. The notice interpretation module 610 can instruct the processor 602 to interpret machine readable privacy notices sent from remote devices, such as IoT devices and the like. In addition, a notice display module 612 can cause the processor 602 to display the privacy notices from remote devices to the user of a computing device. This allows the user to make appropriate privacy choices based on the type of remote device requesting access and the data it requests, among other factors.

It should be understood that any number of additional software components not shown in FIG. 6 may be included within the tangible, non-transitory, computer-readable medium 600, depending on the application or other considerations. Moreover, while four modules, a policy definition module 606, policy assertion module 608, notice interpretation module 610, and notice display module 612 are depicted, fewer or additional modules directed to other applications and types of usages may be stored on medium 600. For example, the computer readable medium 600 can also include, in some examples, a metadata generation module. The metadata generation module can be to associate user privacy preferences with data that has been collected by remote devices, and privacy choices can automatically be enabled and honored when subsequent remote devices request access to similar data.

The computer readable media 600 may also include a policy interpretation module that can be executed a receiving device requesting and receiving data from a user device. The policy interpretation module may be used by the receiving device to interpret the user privacy policy. In a particular instance, the policy interpretation module is provided from the user device to the receiving device for execution by the receiving device. In another example, the computer readable media 600 may include a notice assertion module that can be executed by the receiving device requesting and receiving data from the user device. The notice assertion module may provide notice of information handling practices by the receiving device (and associated entity) to the user device. In a specific example, the notice assertion module may be provided from the user device to the receiving device for execution at the receiving device.

In summary, an embodiment may include a computing device having a processor and memory. The memory stores an application and instructions executable by the processor to adjust access of a smart device, e.g., an IoT device to user data on a computing device. While the smart device may be a “remote” smart device, the smart device can be disposed locally to the computing device. The framework is to adhere to privacy preferences of the computer device and to customize a privacy policy based on user preferences, the specific or sensitive data, and the type and/or entity of smart device requesting access, and so on.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment”, “one embodiment”, “some embodiments”, “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

### EXAMPLES

Example 1 is a method for privacy management between computing devices. The method includes defining, via a first computing device, a user privacy policy for the first computing device based on the privacy preferences of a user of the first computing device, the user privacy policy to be asserted in machine readable format across multiple computing devices requesting access to data of the first computing device; receiving at the first computing device an access request from a second computing device; and asserting, via the first computing device, the user privacy policy in the machine readable format to the second computing device.

Example 2 includes the method of example 1, including or excluding optional features. In this example, the method includes converting, via the first computing device, the user privacy policy into the machine readable format; and interpreting the user privacy policy at the second computing device. Optionally, the method includes interpreting the user privacy policy at the second computing device includes the second computing device executing an interpretation engine provided by the first computing device, wherein the user privacy policy is asserted to the second computing device in response to the access request, wherein the user privacy policy includes a first setting with respect to accessing contacts of the user on the first computing device and a second setting with respect to location of the first computing device, and wherein the second computing device includes a plurality of second computing devices including the multiple computing devices.

Example 3 includes the method of any one of examples 1 to 2, including or excluding optional features. In this example, the method includes implementing the access request in accordance with the user privacy policy as interpreted at the second computing device.

Example 4 includes the method of any one of examples 1 to 3, including or excluding optional features. In this example, the method includes the first computing device alerting the user and providing options to the user in response to the second computing device unable to meet the user privacy policy, and wherein the options include: a first option including the user to change a setting of the user privacy policy; a second option including the user to choose not to proceed with the access request; and a third option including the user to allow an exception to the user privacy policy.

Example 5 includes the method of any one of examples 1 to 4, including or excluding optional features. In this example, the method includes the user making a selection to enable the first computing device to broadcast assertions of the user privacy policy to the multiple computing devices, wherein defining the user privacy policy includes the first computing device generating and displaying a user interface (UI) to the user to receive inputs from the user to define the user privacy policy to be asserted across the multiple computing devices, wherein the first computing device stores code executed by a processor of the first computing device to generate and display the UI, and wherein defining and asserting does not include the user employing a user interface provided by the multiple computing devices including the second computing device.

Example 6 includes the method of any one of examples 1 to 5, including or excluding optional features. In this example, the method includes generating metadata, the metadata associating the user privacy policy with data collected via the access request by the second computing device from the first computing device; making the metadata available to a third computing device; and the third computing device utilizing the metadata to satisfy the user privacy policy.

Example 7 includes the method of any one of examples 1 to 6, including or excluding optional features. In this example, the method includes the first computing device asserting the user privacy policy to an application making a local access request, the application stored and executing locally on the first computing device.

Example 8 includes the method of any one of examples 1 to 7, including or excluding optional features. In this example, the method includes asserting a privacy notice from the second computing device to the first computing device; and interpreting the privacy notice at the first computing device. Optionally, the method includes displaying, via the first computing device, the privacy notice to the user; and adjusting, via the first computing device, the user privacy policy in response to the privacy notice, wherein the privacy notice includes notice with respect to marketing of user data. Optionally, asserting the privacy notice includes transmitting the privacy notice to the first computing device in a machine readable format, wherein the privacy notice includes practices of information collection and handling, and wherein the second computing device includes a remote computing device wirelessly coupled to the first computing device.

Example 9 includes the method of any one of examples 1 to 8, including or excluding optional features. In this example, the second computing device includes a smart device in a public environment and within wireless range of the first computing device, and wherein the smart device includes an Internet of Things (IoT) device.

Example 10 is a system incorporating privacy management. The system includes a first computing device configured to: define a user privacy policy including a user privacy setting for a user of the first computing device, the user privacy policy to be asserted by the first computing device across multiple computing devices; convert the user privacy policy into a machine readable format; receive an access request from a second computing device; assert the user privacy policy in the machine readable format to the second computing device in response to the access request; and implement the access request per the user privacy policy as interpreted at the second computing device.

Example 11 includes the system of example 10, including or excluding optional features. In this example, the first computing device is configured to alert the user and provide options to the user in response to the second computing device unable to meet the user privacy policy. Optionally, the options include: a first option including the user to change the user privacy setting of the user privacy policy; a second option including the user to choose not to proceed with the access request; and a third option including the user to allow an exception to the user privacy setting.

Example 12 includes the system of any one of examples 10 to 11, including or excluding optional features. In this example, first computing device is configured to provide an interpretation engine to the second computing device, wherein the second computing device includes a smart device in a public environment and within wireless range of the first computing device, and wherein the smart device includes an Internet of Things (IoT) device.

Example 13 includes the system of any one of examples 10 to 12, including or excluding optional features. In this example, the first computing device is configured to convert a privacy notice received in machine readable format from the second computing device into a format that is readable by the user, and to display the privacy notice to the user, wherein the privacy notice includes notice of an information handling practice of an entity associated with the second computing device, and wherein the second computing device includes a remote computing device wirelessly coupled to the first computing device. Optionally, the system includes the second computing device including an interpretation engine to interpret the user privacy policy, the second computing device further configured to: assert a privacy notice in machine readable format to the first computing device; generate metadata associating the user privacy policy with data collected from the first computing device by the second computing device; and store the metadata on a network device; and a third computing device configured to honor the user privacy settings based on the metadata.

Example 14 is a tangible, non-transitory, computer-readable medium. The computer-readable medium includes instructions that direct the processor to define at a computing device a user privacy policy based on the privacy preferences of a user of the computing device, the user privacy policy to be asserted in machine readable format across multiple remote computing devices requesting access to data of the computing device; provide at the computing device a selectable option for the user to enable the computing device to broadcast assertions of the user privacy policy in the machine readable format to the multiple remote computing devices, convert at the computing device the user privacy policy into the machine readable format; assert the user privacy policy in the machine readable format from the computing device to a remote computing device in response to the computing device receiving an access request from the remote computing device; and allow implementation at the computing device of the access request per the user privacy policy as interpreted at the remote computing device.

Example 15 includes the computer-readable medium of example 14, including or excluding optional features. In this example, the instructions, when executed by a processor, cause the processor to interpret at the remote computing device the user privacy policy, wherein the remote computing device is wirelessly coupled to the first computing device.

Example 16 includes the computer-readable medium of any one of examples 14 to 15, including or excluding optional features. In this example, the instructions, when executed by a processor, cause the processor to: interpret at the computing device a privacy notice received in machine readable format from the remote computing device; display at the computing device the privacy notice to the user; and display selectable options at the computing device to the user in response to the privacy notice, the selectable options with respect to the access request and asserted user privacy policy. Optionally, the computing device is wirelessly coupled to the remote computing device, and wherein the remote computing device includes an Internet of Things (IoT) device.

Example 17 includes the computer-readable medium of any one of examples 14 to 16, including or excluding optional features. In this example, the instructions, when executed by a processor, cause the processor to generate an association between the user privacy policy and data collected by the remote computing device from the computing device.

Example 18 includes the computer-readable medium of any one of examples 14 to 17, including or excluding optional features. In this example, to define the user privacy policy includes the computing device to generate and display a user interface (UI) to the user to receive inputs from the user to define the user privacy policy to be asserted across the multiple remote computing devices, and wherein to define or assert does not include the user employing a user interface provided by the remote computing device.

Example 19 includes the computer-readable medium of any one of examples 14 to 18, including or excluding optional features. In this example, the instructions, when executed by a processor, cause the processor to assert the user privacy policy at the computing device to an application making a local access request, the application stored and executing locally on the computing device.

Example 20 is a system for privacy management between computing devices. The system includes means for defining, via a first computing device, a user privacy policy for the first computing device based on the privacy preferences of a user of the first computing device, the user privacy policy to be asserted in machine readable format across multiple computing devices requesting access to data of the first computing device; means for receiving at the first computing device an access request from a second computing device; and means for asserting, via the first computing device, the user privacy policy in the machine readable format to the second computing device. Optionally, the system includes means for converting, via the first computing device, the user privacy policy into the machine readable format; and means for interpreting the user privacy policy at the second computing device. Optionally, interpreting the user privacy policy at the second computing device includes the second computing device executing an interpretation engine provided by the first computing device, wherein the user privacy policy is asserted to the second computing device in response to the access request, wherein the user privacy policy includes a first setting with respect to accessing contacts of the user on the first computing device and a second setting with respect to location of the first computing device, and wherein the second computing device includes a plurality of second computing devices including the multiple computing devices. Optionally, the system includes means for implementing the access request in accordance with the user privacy policy as interpreted at the second computing device. Optionally, the system includes means for the first computing device to alert the user and prove options to the user in response to the second computing device unable to meet the user privacy policy, and wherein the options include: a first option including the user to change a setting of the user privacy policy; a second option including the user to choose not to proceed with the access request; and a third option including the user to allow an exception to the user privacy policy. Optionally, the system includes means for the user to make a selection to enable the first computing device to broadcast assertions of the user privacy policy to the multiple computing devices, wherein defining the user privacy policy includes the first computing device generating and displaying a user interface (UI) to the user to receive inputs from the user to define the user privacy policy to be asserted across the multiple computing devices, wherein the first computing device stores code executed by a processor of the first computing device to generate and display the UI, and wherein defining and asserting does not include the user employing a user interface provided by the multiple computing devices including the second computing device. Optionally, the system includes means for generating metadata, the metadata associating the user privacy policy with data collected via the access request by the second computing device from the first computing device; means for making the metadata available to a third computing device; and the third computing device utilizing the metadata to satisfy the user privacy policy. Optionally, the system includes means for the first computing device asserting the user privacy policy to an application making a local access request, the application stored and executing locally on the first computing device. Optionally, the system includes means for asserting a privacy notice from the second computing device to the first computing device, and means for interpreting the privacy notice at the first computing device. Optionally, the system includes means for displaying, via the first computing device, the privacy notice to the user; and means for adjusting, via the first computing device, the user privacy policy in response to the privacy notice, wherein the privacy notice includes notice with respect to marketing of user data. Optionally, asserting the privacy notice includes transmitting the privacy notice to the first computing device in a machine readable format, wherein the privacy notice includes practices of information collection and handling, and wherein the second computing device includes a remote computing device wirelessly coupled to the first computing device. Optionally, the second computing device includes a smart device in a public environment and within wireless range of the first computing device, and wherein the smart device includes an Internet of Things (IoT) device.

Example 21 is a method for privacy management between computing devices. The method includes defining, via a first computing device, a user privacy policy for the first computing device based on the privacy preferences of a user of the first computing device, the user privacy policy to be asserted in machine readable format across multiple computing devices requesting access to data of the first computing device; receiving at the first computing device an access request from a second computing device; asserting, via the first computing device, the user privacy policy in the machine readable format to the second computing device; converting, via the first computing device, the user privacy policy into the machine readable format; and interpreting the user privacy policy at the second computing device. Optionally, the method includes interpreting the user privacy policy at the second computing device includes the second computing device executing an interpretation engine provided by the first computing device, wherein the user privacy policy is asserted to the second computing device in response to the access request, wherein the user privacy policy includes a first setting with respect to accessing contacts of the user on the first computing device and a second setting with respect to location of the first computing device, and wherein the second computing device includes a plurality of second computing devices including the multiple computing devices. Optionally, the method includes implementing the access request in accordance with the user privacy policy as interpreted at the second computing device; and including the user making a selection to enable the first computing device to broadcast assertions of the user privacy policy to the multiple computing devices, wherein defining the user privacy policy includes the first computing device generating and displaying a user interface (UI) to the user to receive inputs from the user to define the user privacy policy to be asserted across the multiple computing devices, wherein the first computing device stores code executed by a processor of the first computing device to generate and display the UI, and wherein defining and asserting does not include the user employing a user interface provided by the multiple computing devices including the second computing device. Optionally, the method includes the first computing device alerting the user and providing options to the user in response to the second computing device unable to meet the user privacy policy, and wherein the options include: a first option including the user to change a setting of the user privacy policy; a second option including the user to choose not to proceed with the access request; and a third option including the user to allow an exception to the user privacy policy. Optionally, the method includes generating metadata, the metadata associating the user privacy policy with data collected via the access request by the second computing device from the first computing device; making the metadata available to a third computing device; asserting a privacy notice from the second computing device to the first computing device; interpreting the privacy notice at the first computing device; the first computing device asserting the user privacy policy to an application making a local access request, the application stored and executing locally on the first computing device; and the third computing device utilizing the metadata to satisfy the user privacy policy. Optionally, the method includes displaying, via the first computing device, the privacy notice to the user; and adjusting, via the first computing device, the user privacy policy in response to the privacy notice, wherein the privacy notice includes notice with respect to marketing of user data; and wherein asserting the privacy notice includes transmitting the privacy notice to the first computing device in a machine readable format, wherein the privacy notice includes practices of information collection and handling, wherein the second computing device includes a remote computing device wirelessly coupled to the first computing device, wherein the second computing device is in a public environment and within wireless range of the first computing device, and wherein the remote computing device includes an Internet of Things (IoT) device.

Example 22 is a system incorporating privacy management, the system. The system includes instructions that direct the processor to a first computing device configured to: define a user privacy policy including a user privacy setting for a user of the first computing device, the user privacy policy to be asserted by the first computing device across multiple computing devices; convert the user privacy policy into a machine readable format; receive an access request from a second computing device; assert the user privacy policy in the machine readable format to the second computing device in response to the access request; and implement the access request per the user privacy policy as interpreted at the second computing device. Optionally, the first computing device is configured to alert the user and provide options to the user in response to the second computing device unable to meet the user privacy policy, and wherein the options include: a first option including the user to change the user privacy setting of the user privacy policy; a second option including the user to choose not to proceed with the access request; and a third option including the user to allow an exception to the user privacy setting. Optionally, the first computing device is configured to provide an interpretation engine to the second computing device, wherein the second computing device includes a smart device in a public environment and within wireless range of the first computing device, and wherein the smart device includes an Internet of Things (IoT) device. Optionally, the first computing device is configured to convert a privacy notice received in machine readable format from the second computing device into a format that is readable by the user, and to display the privacy notice to the user, wherein the privacy notice includes notice of an information handling practice of an entity associated with the second computing device, and wherein the second computing device includes a remote computing device wirelessly coupled to the first computing device. Optionally, the system includes the second computing device including an interpretation engine to interpret the user privacy policy, the second computing device further configured to: assert a privacy notice in machine readable format to the first computing device; generate metadata associating the user privacy policy with data collected from the first computing device by the second computing device; store the metadata on a network device; and a third computing device configured to honor the user privacy settings based on the metadata.

Example 23 is a tangible, non-transitory, computer-readable medium. The computer-readable medium includes instructions that direct the processor to define at a computing device a user privacy policy based on the privacy preferences of a user of the computing device, the user privacy policy to be asserted in machine readable format across multiple remote computing devices requesting access to data of the computing device; provide at the computing device a selectable option for the user to enable the computing device to broadcast assertions of the user privacy policy in the machine readable format to the multiple remote computing devices, convert at the computing device the user privacy policy into the machine readable format; assert the user privacy policy in the machine readable format from the computing device to a remote computing device in response to the computing device receiving an access request from the remote computing device; and allow implementation at the computing device of the access request per the user privacy policy as interpreted at the remote computing device. Optionally, the instructions, when executed by a processor, cause the processor to: interpret at the computing device a privacy notice received in machine readable format from the remote computing device; display at the computing device the privacy notice to the user; display selectable options at the computing device to the user in response to the privacy notice, the selectable options with respect to the access request and asserted user privacy policy; generate an association between the user privacy policy and data collected by the remote computing device from the computing device; and assert the user privacy policy at the computing device to an application making a local access request, the application stored and executing locally on the computing device. Optionally, the computing device is wirelessly coupled to the remote computing device, and wherein the remote computing device includes an Internet of Things (IoT) device, wherein to define the user privacy policy includes the computing device to generate and display a user interface (UI) to the user to receive inputs from the user to define the user privacy policy to be asserted across the multiple remote computing devices, and wherein to define or assert does not include the user employing a user interface provided by the remote computing device.

What is claimed is:

1. A method for privacy management between computing devices, comprising:
defining, via a first computing device, a user privacy policy for the first computing device based on the privacy preferences of a user of the first computing device, the user privacy policy to be asserted in machine readable format across multiple computing devices requesting access to data of the first computing device;
receiving at the first computing device an access request from a second computing device; and
asserting, via the first computing device, the user privacy policy in the machine readable format to the second computing device.

2. The method of claim 1, comprising:
converting, via the first computing device, the user privacy policy into the machine readable format; and
interpreting the user privacy policy at the second computing device.

3. The method of claim 2, wherein interpreting the user privacy policy at the second computing device comprises the second computing device executing an interpretation engine provided by the first computing device, wherein the user privacy policy is asserted to the second computing device in response to the access request, wherein the user privacy policy comprises a first setting with respect to accessing contacts of the user on the first computing device and a second setting with respect to location of the first computing device, and wherein the second computing device comprises a plurality of second computing devices comprising the multiple computing devices.

4. The method of claim 1, comprising implementing the access request in accordance with the user privacy policy as interpreted at the second computing device.

5. The method of claim 1, comprising the first computing device alerting the user and providing options to the user in response to the second computing device unable to meet the user privacy policy, and wherein the options comprise:
a first option comprising the user to change a setting of the user privacy policy;
a second option comprising the user to choose not to proceed with the access request; and
a third option comprising the user to allow an exception to the user privacy policy.

6. The method of claim 1, comprising the user making a selection to enable the first computing device to broadcast assertions of the user privacy policy to the multiple computing devices, wherein defining the user privacy policy comprises the first computing device generating and displaying a user interface (UI) to the user to receive inputs from the user to define the user privacy policy to be asserted across the multiple computing devices, wherein the first computing device stores code executed by a processor of the first computing device to generate and display the UI, and wherein defining and asserting does not comprise the user employing a user interface provided by the multiple computing devices comprising the second computing device.

7. The method of claim 1, comprising:
generating metadata, the metadata associating the user privacy policy with data collected via the access request by the second computing device from the first computing device;
making the metadata available to a third computing device; and
the third computing device utilizing the metadata to satisfy the user privacy policy.

8. The method of claim 1, comprising the first computing device asserting the user privacy policy to an application making a local access request, the application stored and executing locally on the first computing device.

9. The method of claim 1, comprising:
asserting a privacy notice from the second computing device to the first computing device; and
interpreting the privacy notice at the first computing device.

10. The method of claim 9, comprising:
displaying, via the first computing device, the privacy notice to the user; and
adjusting, via the first computing device, the user privacy policy in response to the privacy notice, wherein the privacy notice comprises notice with respect to marketing of user data.

11. The method of claim 9, wherein asserting the privacy notice comprises transmitting the privacy notice to the first computing device in a machine readable format, wherein the privacy notice comprises practices of information collection and handling, and wherein the second computing device comprises a remote computing device wirelessly coupled to the first computing device.

12. The method of claim 1, wherein the second computing device comprises a smart device in a public environment and within wireless range of the first computing device, and wherein the smart device comprises an Internet of Things (IoT) device.

13. A system incorporating privacy management, the system comprising:
a first computing device configured to:
define a user privacy policy comprising a user privacy setting for a user of the first computing device, the user privacy policy to be asserted by the first computing device across multiple computing devices;
convert the user privacy policy into a machine readable format;
receive an access request from a second computing device;
assert the user privacy policy in the machine readable format to the second computing device in response to the access request; and
implement the access request per the user privacy policy as interpreted at the second computing device.

14. The system of claim 13, wherein the first computing device is configured to alert the user and provide options to the user in response to the second computing device unable to meet the user privacy policy.

15. The system of claim 14, wherein the options comprise:
a first option comprising the user to change the user privacy setting of the user privacy policy;
a second option comprising the user to choose not to proceed with the access request; and
a third option comprising the user to allow an exception to the user privacy setting.

16. The system of claim 13, wherein first computing device is configured to provide an interpretation engine to the second computing device, wherein the second computing device comprises a smart device in a public environment and within wireless range of the first computing device, and wherein the smart device comprises an Internet of Things (IoT) device.

17. The system of claim 13, wherein the first computing device is configured to convert a privacy notice received in machine readable format from the second computing device into a format that is readable by the user, and to display the privacy notice to the user, wherein the privacy notice comprises notice of an information handling practice of an entity associated with the second computing device, and wherein the second computing device comprises a remote computing device wirelessly coupled to the first computing device.

18. The system of claim 17, comprising:
the second computing device comprising an interpretation engine to interpret the user privacy policy, the second computing device further configured to:
assert a privacy notice in machine readable format to the first computing device;
generate metadata associating the user privacy policy with data collected from the first computing device by the second computing device; and
store the metadata on a network device; and
a third computing device configured to honor the user privacy settings based on the metadata.

19. A tangible, non-transitory, computer-readable medium comprising instructions that, when executed by a processor, direct the processor to:
define at a computing device a user privacy policy based on the privacy preferences of a user of the computing device, the user privacy policy to be asserted in machine readable format across multiple remote computing devices requesting access to data of the computing device;
provide at the computing device a selectable option for the user to enable the computing device to broadcast assertions of the user privacy policy in the machine readable format to the multiple remote computing devices,
convert at the computing device the user privacy policy into the machine readable format;
assert the user privacy policy in the machine readable format from the computing device to a remote computing device in response to the computing device receiving an access request from the remote computing device; and
allow implementation at the computing device of the access request per the user privacy policy as interpreted at the remote computing device.

20. The tangible, non-transitory, computer-readable medium of claim 19, wherein the instructions, when executed by a processor, cause the processor to interpret at the remote computing device the user privacy policy, wherein the remote computing device is wirelessly coupled to the first computing device.

21. The tangible, non-transitory, computer-readable medium of claim 19, wherein the instructions, when executed by a processor, cause the processor to:
interpret at the computing device a privacy notice received in machine readable format from the remote computing device;
display at the computing device the privacy notice to the user; and
display selectable options at the computing device to the user in response to the privacy notice, the selectable options with respect to the access request and asserted user privacy policy.

22. The tangible, non-transitory, computer-readable medium of claim 19, wherein the computing device is wirelessly coupled to the remote computing device, and wherein the remote computing device comprises an Internet of Things (IoT) device.

23. The tangible, non-transitory, computer-readable medium of claim 19, wherein the instructions, when executed by a processor, cause the processor to generate an association between the user privacy policy and data collected by the remote computing device from the computing device.

24. The tangible, non-transitory, computer-readable medium of claim 19, wherein to define the user privacy policy comprises the computing device to generate and display a user interface (UI) to the user to receive inputs from the user to define the user privacy policy to be asserted across the multiple remote computing devices, and wherein to define or assert does not comprise the user employing a user interface provided by the remote computing device.

25. The tangible, non-transitory, computer-readable medium of claim 19, wherein the instructions, when executed by a processor, cause the processor to assert the user privacy policy at the computing device to an application making a local access request, the application stored and executing locally on the computing device.
